(19) United States
(12) Patent Application Publication
(10) Pub. No.: US 2007/0256748 A1
(43) Pub. Date: Nov. 8, 2007

(54) Fluid dispenser device and a method of manufacturing a valve member

(75) Inventor: Xavier Brahim, Conches en Ouches (FR)

Correspondence Address: SUGHRUE MION, PLLC, 2100 PENNSYLVANIA AVENUE, N.W., SUITE 800, WASHINGTON, DC, 20037, US

(73) Assignee: VALOIS SAS, Le Neubourg (FR)

(21) Appl. No.: 11/797,439

(22) Filed: May 3, 2007

Related U.S. Application Data
(60) Provisional application No. 60/874,491, filed on Dec. 13, 2006.

(30) Foreign Application Priority Data
May 4, 2006 (FR) FR-06/51614

(51) Int. Cl. B65D 88/54; F16K 15/14

(52) U.S. Cl. 137/854; 222/321.7

(57) ABSTRACT

A fluid dispenser device (1) for associating with a fluid reservoir (3), the device including at least one check valve (12, 2) that is suitable for controlling the flow of fluid through the device, the check valve comprising a seat (12), and a movable valve member (2) that defines a contact zone that is suitable for bearing against the seat (12) in leaktight manner, the device including resilient prestress means (23) that urge the valve member in leaktight contact against its seat (12) at rest, the device being characterized in that the prestress means (23) are formed integrally with the valve member.

### CROSS REFERENCE TO RELATED APPLICATION

This application claims the benefit under 35 U.S.C. §119(e) of pending U.S. provisional patent application Ser. No. 60/874,491, filed Dec. 13, 2006, and priority under 35 U.S.C. §119(a)-(d) of French patent application No. FR-06.51614, filed May 4, 2006.

### TECHNICAL FIELD

The present invention relates to a fluid dispenser device for associating with a fluid reservoir, the device including at least one check valve that is suitable for controlling the flow of fluid through the device. The present invention also relates to a method of manufacturing a valve member that is insertable in a fluid dispenser device. Such a device and such a method can be used in numerous fields, such as the fields of perfumery, cosmetics, or even pharmacy, for example.

### BACKGROUND OF THE INVENTION

Various fluid dispenser devices using one or more check valves have been known of for some considerable time. In particular, mention can be made of pumps and valves. Generally, that type of dispenser device includes one or two check valves that are respectively provided at the inlet and/or at the outlet of an internal dispenser chamber. Each check valve generally comprises a seat, and a movable valve member that defines a contact zone that is suitable for bearing selectively against the seat in leaktight manner, thereby controlling the flow of fluid at the inlet and/or at the outlet of the dispenser chamber. This is valid for pumps and valves, and also applies to other dispenser devices that use one or more check valves to control the flow of fluid.

In the prior art, it is also known to urge the valve member against its seat by resilient prestress means that can be implemented in a wide variety of forms. By way of example, the prestress means can be a metal spring that presses the valve member against its seat. The resilient prestress means can also be made of plastics material and can be fitted on the valve member so as to urge it towards its seat. The advantage of the resilient prestress means is that the check valve closes more quickly, i.e. the valve member returns more quickly against its seat. This is particularly advantageous when the fluid is of high viscosity and tends to support the valve member. In addition, the resilient prestress means can be used to urge the valve member against its seat even while the check valve is at rest.

### BRIEF SUMMARY OF THE INVENTION

An object of the present invention is to improve prior-art prestressed check valves by defining a check valve that is easier to make and that is easier to assemble, while guaranteeing that the check valve operates well and is leaktight.

To do this, the present invention proposes a fluid dispenser device for associating with a fluid reservoir, the device including at least one check valve that is suitable for controlling the flow of fluid through the device, the check valve comprising a seat, and a movable valve member that defines a contact zone that is suitable for bearing against the seat in leaktight manner, the device including resilient prestress means that urge the valve member in leaktight contact against its seat at rest, the device being characterized in that the prestress means are formed integrally with the valve member. The valve member is thus automatically prestressed as soon as it is put into place on its seat. There is no need for an additional part or element to be fitted on the valve member or on the seat in order to provide the resilient prestress function.

The prestress means advantageously bear against an abutment surface that is secured to the seat. The seat is advantageously situated between the contact zone and the abutment surface. The seat and the abutment surface are preferably situated between the contact zone and the prestress means. The valve member is thus held captive by the seat and by the abutment surface that limits its displacement in both directions. While the valve member is moving away from its seat, the prestress means press even harder against the abutment surface, thereby tending to return the valve member against its seat.

In a practical embodiment, the prestress means comprise resilient tabs having free ends that are engaged with the abutment surface. The tabs are advantageously separated by slots that define flow passages for the fluid. The resilient prestress function is thus provided by the resilient deformation of the tabs having free ends that bear under the seat against the abutment surface.

According to another advantageous characteristic, the prestress means are prestressed against the abutment surface, while the valve member is resting against its seat. Said prestress ensures that the check valve is perfectly leaktight even while it is at rest. This can be achieved with resilient tabs having free ends that press a little against the abutment surface even while the check valve is closed.

In another aspect of the invention, the dispenser device includes a body forming an inlet duct for communicating with the reservoir, the duct having a fluid inlet and a fluid outlet, the seat being formed at the outlet from the inlet duct, the duct also forming an inner shoulder that faces towards the inlet of the duct, the shoulder forming said abutment surface, the seat and the shoulder facing in diverging directions. In this embodiment, the valve member is held captive in the inlet duct, and can only be displaced in very limited manner against the resilient prestress means that always return it into leaktight contact against its seat.

In a practical embodiment, the valve member includes a valve rod from which a frustoconical brim extends outwards, the brim forming a contact zone, the prestress means also extending outwards from the valve rod. The prestress means are advantageously folded up towards the rod by pressing against the seat while the valve member is being put into place on its seat. When the prestress means are in the form of resilient tabs, said resilient tabs can extend completely radially outwards on being unmolded, and can be folded up towards the rod while the valve member is being put into place on its seat. By pushing the valve member home against its seat, the free ends of the resilient tabs are received under the shoulder of the inlet duct forming the abutment surface. From that moment on, the valve member is held captive by its seat.

The present invention also defines a method of manufacturing a valve member including: a contact zone for coming into leaktight contact with a valve seat; and resilient prestress means for urging the contact zone towards its seat, the method comprising molding the valve member integrally with the resilient prestress means that are extended in an unmolded configuration, and then deforming the resilient prestress means into an assembled configuration. The prestress means are advantageously deformed against the seat, so as to reach their assembled configuration. The unmolded configuration can be substantially or completely radial, and the assembled configuration defines an axial component that is greater than the axial component of the unmolded configuration.

The valve member of the present invention thus integrates resilient prestress means that do not require any additional element other than the valve seat in order to become operational.

### BRIEF DESCRIPTION OF THE DRAWINGS

The invention is described more fully below with reference to the accompanying drawings which show an embodiment of the invention by way of non-limiting example.

In the figures:

FIG. 1 is a fragmentary vertical-section view through a dispenser device of the invention mounted in a fluid dispenser;

FIGS. 2 and 3 are much larger-scale perspective views of the valve member of FIG. 1;

FIGS. 4a, 4b, and 4c are vertical-section views showing a valve member of the invention being assembled on a valve seat;

FIG. 5 is a view similar to FIG. 4b showing a variant embodiment; and

FIG. 6 is a view similar to FIG. 4a showing another variant embodiment of the invention.

### DETAILED DESCRIPTION

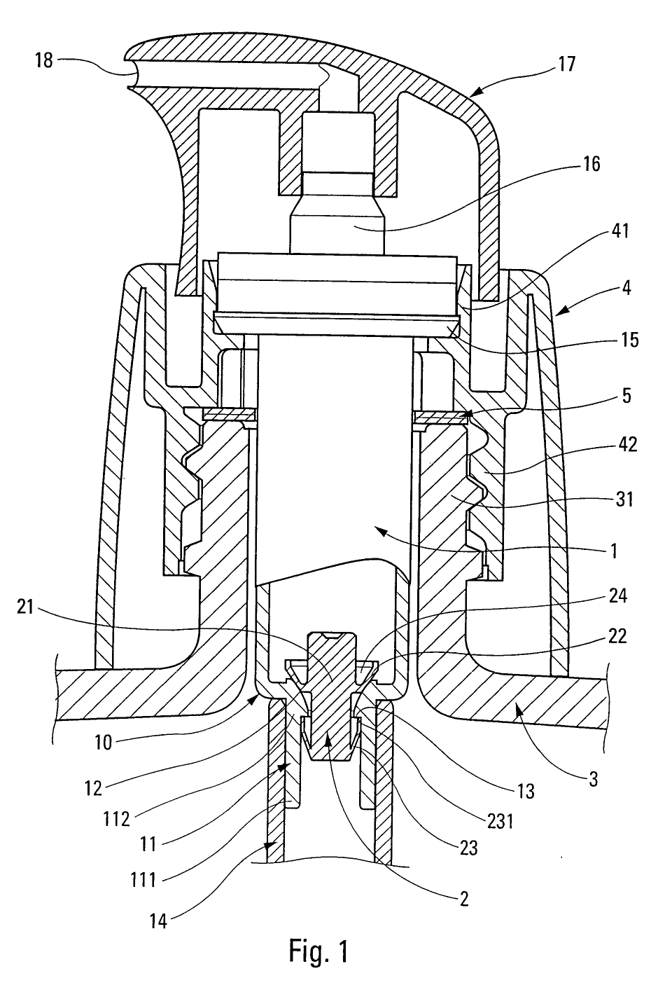

FIG. 1 is a view of the top portion of a fluid dispenser including a dispenser device 1 mounted on a neck 31 of a reservoir 3 by means of a fastener ring 4. More precisely, the dispenser device 1 includes a body 10 defining an inlet duct 11 to which a dip tube 14 can be connected. The body 10 also defines a projecting collar 15 that is engaged in a reception housing 41 formed by the fastener ring 4. In addition, the ring includes a skirt 42 that is internally threaded and that is engaged by meshing with an external thread on the neck 31. The dispenser device 1 also includes an actuator rod 16 that is axially displaceable down and up at the top end of the body 10. The actuator rod 16 is associated with a piston (not shown) that slides inside the body 10. The actuator rod 16 is provided with a pusher 17 that advantageously defines a dispenser orifice 18. By pressing on the pusher 17, the user displaces the actuator rod 16, thereby causing fluid to be dispensed through the dispenser orifice 18. This is a fairly conventional design for a fluid dispenser in the field of cosmetics for dispensing high-viscosity fluids. The dispenser device 1 can be a pump or a valve. In FIG. 1, it is a cosmetics pump.

Still with reference to FIG. 1, it can be seen that the body 10 defines an inlet valve seat 12 that is defined at the outlet 112 of the inlet duct 11. The inlet 111 of the inlet duct 11 is connected to the dip tube 14. In this embodiment, the seat 12 is frustoconically shaped, flaring away from the duct 11, i.e. towards the inside of the body 10. Under the seat 12, an inner projection projects into the inlet duct 11 forming an inner shoulder 13 that faces towards the inlet 111 of the duct 11. With reference to FIG. 1, it is also possible to say that the frustoconical seat 12 faces generally upwards, whereas the shoulder 13 faces downwards. In other words, the seat 12 and the shoulder 13 face in diverging or opposite directions. It should also be observed that the shoulder 13 is very simple to form by molding from the inlet 111 of the duct. The frustoconical seat 12 is also simple to form. The seat 12 can also be formed with a shape other than frustoconical, e.g. completely plane.

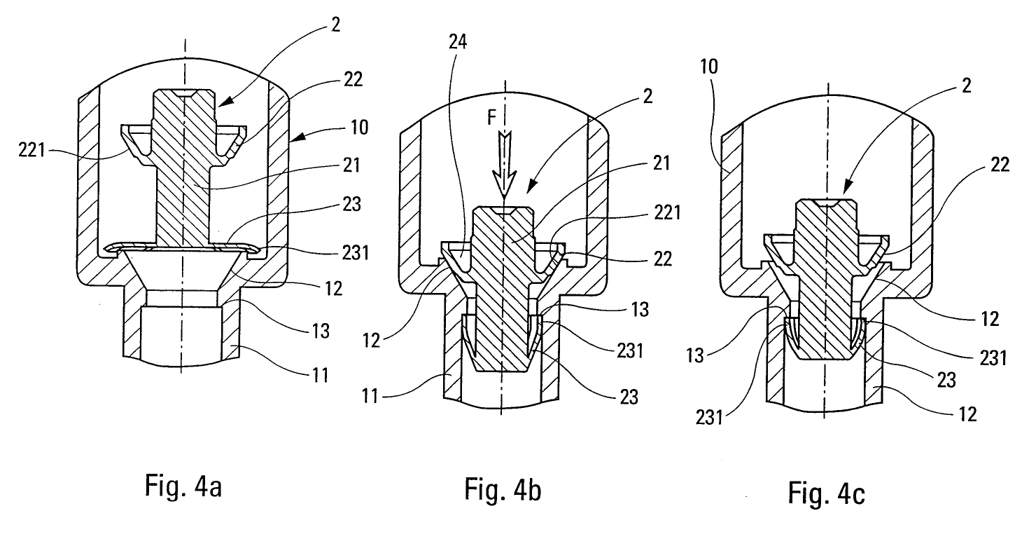

The dispenser device also includes an inlet valve member 2 for co-operating with the seat 12 for selectively controlling the flow of fluid from the inlet duct 11 to the inside of the body 10. The valve member 2 includes a central axial rod 21 that extends along the same axis as the duct 11 and the body 10. A brim 22 extends outwards in frustoconical manner from the central rod 21. It can be said that the brim 22 extends outwards and upwards from the rod 21 in a direction and with an inclination that correspond to the direction and the inclination of the frustoconical seat 12. The brim 22 defines a frustoconical outer contact zone 221 for coming into leaktight contact against the seat 12, as shown in FIGS. 1 and 4b. The brim 22 is spaced apart from the rod 21 by an annular intermediate gap 24 that thus enables the brim 22 to be deformed radially inwards, as described below. The valve member also defines resilient prestress means, which, in this embodiment, are in the form of flexible or resilient tabs or blades 23 that extend outwards from the central rod 21. In FIGS. 1 and 4b, it can be seen that the tabs 23 extend outwards and upwards from the rod 21. The resilient tabs 23 define free ends 231 that are engaged under the shoulder 13 that thus forms an annular abutment surface.

The position shown in FIGS. 1 and 4b is the assembled position of the valve member at rest, i.e. when the dispenser is not actuated. It can be seen that the brim 22 is in leaktight contact against the seat 12, and that the free ends 231 of the tabs 23 bear against the shoulder 13. As a result, the brim 22 is pressed against its seat 12 as a result of the resilient characteristic of the tabs 23 that are prestressed a little while in the rest position. It is thus not only gravity that causes the valve member to rest against its seat.

Still with reference to FIGS. 1 and 4b, it should be observed that the bottom portion of the valve member 2 is engaged inside the inlet duct 11, with its top portion projecting inside the body 10, i.e. beyond the seat 12. The valve member thus reduces the useful flow section of the inlet duct 11, which useful flow section is thus merely defined by the slots 232 defined between each tab 231.

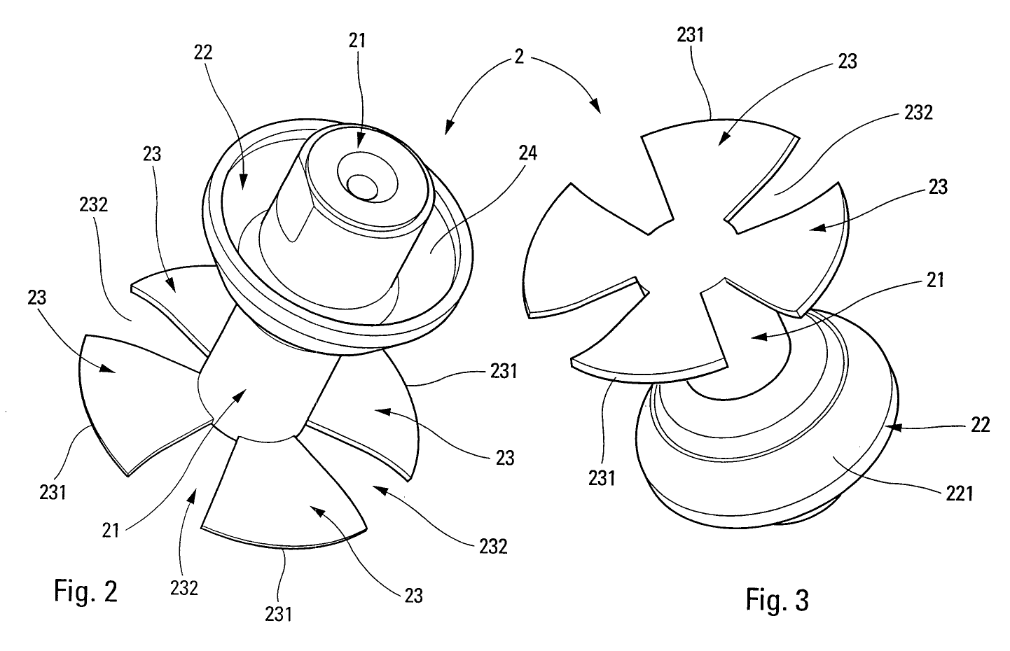

Reference is made below to FIGS. 2 and 3 which show, in larger-scale manner, the valve member 2 of FIG. 1 on being unmolded. This means that the valve member is not yet subjected to any prestress: the tabs 23 extend radially from the central rod 21 in a substantially plane configuration. This can be seen more clearly in FIG. 4a. The tabs 23 can be made to curve downwards a little at their free ends 231, as can be seen in the figures. The curve enables the free ends 231 to hold better under the shoulder 13. It should also be observed in FIGS. 2 and 3 that the tabs 23 are separated by slots 232 that define the useful flow section of the inlet duct 11 once the valve member is in place on its seat, as shown in FIGS. 1, 4b, and 4c. The intermediate annular space 24 that spaces the brim 22 apart from the central rod 21 can be seen clearly in FIG. 2.

Reference is made below to FIGS. 4a, 4b, and 4c in order to explain how the valve member of FIGS. 2 and 3 is put into place in a pump or valve body that forms a seat 12. In its unmolded configuration in FIGS. 2 and 3, the valve member 2 is inserted into the body 10 via its top end remote from the inlet duct 11. The valve member 2 thus comes to rest with its tabs 23 against the top edge of the frustoconical seat 12. The valve member 2 is not yet subjected to any prestress. From this position, shown in FIG. 4a, axial pressure starts to be exerted on the valve member 2 in the direction of arrow F shown in FIG. 4b. As a result of their thin wall thickness, the tabs 23 present good flexibility, thereby enabling them to deform elastically by pressing against the seat 12. The tabs 23 thus fold up towards the central rod 21 while the valve member 2 is being pushed into the seat 12 and the duct 11. The tabs 23 thus continue to be folded up inside the duct 11 until their free ends 231 are received under the shoulder 13. To achieve the position shown in FIG. 4b, it is necessary to exert relatively strong pressure on the valve member 2, since it is desirable for the tabs 23 to be prestressed a little while the brim 22 bears against the seat 12 in leaktight manner. It is thus necessary to cause the valve member 2 to penetrate into the duct 11 by deforming the brim 22 a little against the seat 12. This is possible as a result of the wall thickness of the brim 22 being thin, and as a result of the brim being spaced apart from the central rod 21 by the annular intermediate gap 24. Because of its frustoconical configuration, deforming the brim 22 makes it possible to displace the rod 21 inside the duct 11 over a distance that is short, but nevertheless long enough to enable the free ends 231 of the tabs 23 to become snap-fastened under the shoulder 13. The tab ends 231 snap-fasten automatically as a result of the tabs tending to move away from the rod 21 because of their original radial configuration. It then suffices to release the strong pressure exerted on the valve member, so as to allow the brim 22 to relax. This results in the tabs 23 being deformed a little, so they remain prestressed. The brim 22 is thus pressed a little against its seat even in the rest position. This is possible as a result of the brim 22 being more rigid than the tabs 23.

In operation, as shown in FIG. 4c, the brim 22 can lift off its seat 12, thereby causing further deformation of the flexible tabs 23 that come to bear harder against the shoulder 13. The flow passage is thus open between the inlet of the duct 11 and the inside of the body 10. The fluid flows through the slots 232 defined between the tabs 23, and around the brim 22. Such an open check valve configuration occurs when the pressure differential across the check valve is enough to deform the flexible tabs 23. As soon as the pressure differential is no longer enough, the tabs 23 return to their assembled rest condition shown in FIG. 4b, returning the brim 22 into leaktight contact against its seat 12.

A characteristic of the check valve of the invention is that it does not require any additional part to provide the function of the valve member being resiliently prestressed against its seat. The valve member co-operates only with the seat and the inlet duct 11. It should be observed that the seat 12 and the shoulder 13 are situated axially between the brim 22 and the tabs 23.

The valve member 2 can be made as a single part by injection-molding a plastics material: the flexibility of the tabs and of the brim coming from their thin wall thicknesses.

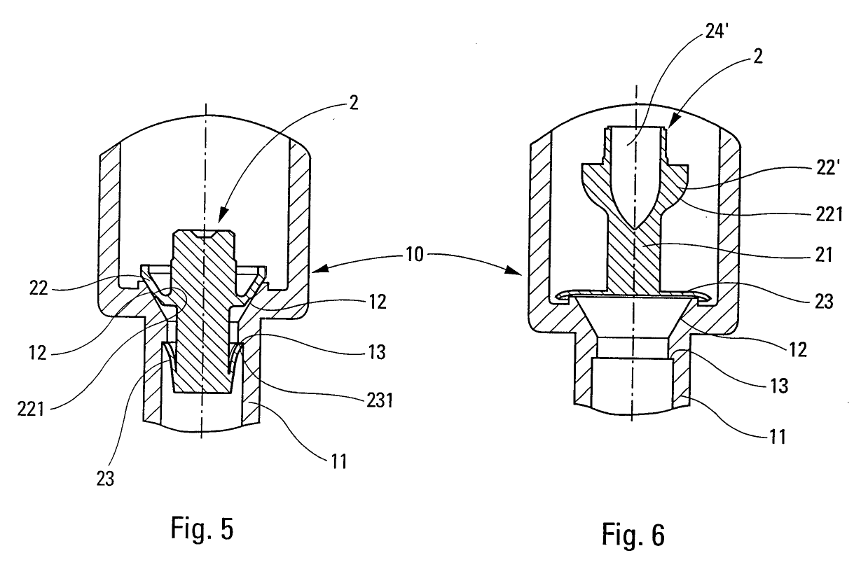

Such a check valve can be used as an inlet valve or as an outlet valve of any dispenser device, such as a pump or a valve, for example. In FIGS. 4b and 4c, it should be observed that the tabs 23 are deformed or deform outwards by making them more convex. As with reference to FIG. 5, it is also possible to envisage that the tabs 23 are deformed inwards by becoming more concave. Both configurations are completely equivalent.

FIG. 6 shows a variant embodiment for the valve member 2. In this embodiment, the brim 22′ defines a rounded contact zone 221, such that the contact with the frustoconical seat 12 is made on an annular line, and no longer against a frustoconical surface. In addition, the brim 22′ does not extend from the central rod 21, defining an annular intermediate gap 24. In contrast, it is the central rod 21 that forms a central gap 24′ about which the brim 22′ is formed. The brim can also thus deform radially inwards when it is pressed hard against its seat 12, so as to enable the ends 231 of the flexible tabs to snap-fasten under the shoulder 13.

Thus, the annular intermediate gap 24 and the central gap 24′ have an identical function of enabling the brim to deform radially inwards into an inner gap when said brim is pressed against its seat.

In the figures, the seat and the contact zone are frustoconically shaped. However, it is possible to envisage other shapes, e.g. plane. It is also possible to provide a seat of a shape that is different from the shape of the contact zone.

The resilient prestress means are described as being made in the form of tabs or blades. In a variant, the resilient means can be in the form of a deformable brim. In addition, the resilient means described are situated axially on the seat, inside the inlet duct. However, it is possible to provide resilient means that are situated axially above the seat, e.g. inside the pump body.

The check valve is particularly well suited to dispensing high-viscosity fluids with which the valve member often encounters difficulties in returning to bear against its valve seat in leaktight manner. This is all the more remarkable given that the valve member is made of a light material, such as plastics material, for example. By means of the resilient prestress means of the invention, the valve member returns immediately against its seat.

1. A fluid dispenser device (1) for associating with a fluid reservoir (3), the device including at least one check valve (12, 2) that is suitable for controlling the flow of fluid through the device, the check valve comprising a seat (12), and a movable valve member (2) that defines a contact zone (221) that is suitable for bearing against the seat (12) in leaktight manner, the device including resilient prestress means (23) that urge the valve member in leaktight contact against its seat (12) at rest, the device being characterized in that the prestress means (23) are formed integrally with the valve member.

2. A fluid dispenser device according to claim 1, in which the prestress means (23) bear against an abutment surface (13) that is secured to the seat (12).

3. A fluid dispenser device according to claim 2, in which the seat (12) is situated between the contact zone (221) and the abutment surface (13).

4. A fluid dispenser device according to claim 3, in which the seat (12) and the abutment surface (13) are situated between the contact zone (221) and the prestress means (23).

5. A fluid dispenser device according to claim 2, in which the prestress means comprise resilient tabs (23) having free ends (231) that are engaged with the abutment surface (13).

6. A fluid dispenser device according to claim 5, in which the tabs (23) are separated by slots (232) that define flow passages for the fluid.

7. A fluid dispenser device according to claim 2, in which the prestress means (23) are prestressed against the abutment surface (13), while the valve member (2) is resting against its seat (12).

8. A fluid dispenser device according to claim 2, including a body (10) forming an inlet duct (11) for communicating with the reservoir (3), the duct having a fluid inlet (111) and a fluid outlet (112), the seat (12) being formed at the outlet (112) from the inlet duct (11), the duct also forming an inner shoulder that faces towards the inlet (111) of the duct, the shoulder forming said abutment surface (13), the seat (12) and the shoulder facing in diverging directions.

9. A fluid dispenser device according to claim 1, in which the valve member (2) includes a valve rod (21) from which a brim (22; 22′) extends outwards, the brim forming the contact zone (221), the prestress means (23) also extending outwards from the valve rod (21).

10. A fluid dispenser device according to claim 9, in which the brim (22; 22′) is deformable radially inwards into an inner gap (24; 24′) on being pressed against its seat.

11. A fluid dispenser device according to claim 9, in which the prestress means (23) are folded up towards the rod (21) by pressing against the seat (12) while the valve member (2) is being put into place on its seat (12).

12. A method of manufacturing a check valve mobile-member (2) including: a contact zone (221) for coming into sealed contact with a valve seat (12); and resilient prestress means (23) for urging the contact zone (221) towards its seat (12), the method comprising molding the valve member (2) integrally with the resilient prestress means (23) that are extended in an unmolded configuration, and then deforming the resilient prestress means (23) into an assembled configuration.

13. A manufacturing method according to claim 12, in which the prestress means (23) are deformed against the seat (12) so as to reach their assembled configuration.

14. A manufacturing method according to claim 12, in which the contact zone (221) is deformed radially inwards against its seat, so as to enable the prestress means to reach their final assembled position.
